(19) United States
(12) Patent Application Publication
(10) Pub. No.: US 2026/0094620 A1
(43) Pub. Date: Apr. 2, 2026

(54) SYSTEMS AND METHODS FOR ASSET EDITING

(71) Applicant: Samsung Electronics Co., Ltd., Gyeonggi-do (KR)

(72) Inventors: Ping HU, Pleasanton, CA (US); Taekhyun KIM, Austin, TX (US); Yanlin ZHOU, San Diego, CA (US); Mostafa EL-KHAMY, San Diego, CA (US)

(21) Appl. No.: 19/340,098

(22) Filed: Sep. 25, 2025

Related U.S. Application Data
(60) Provisional application No. 63/700,425, filed on Sep. 27, 2024.

(51) Int. Cl. G11B 27/036; G06T 5/60; G06T 5/70; G06T 7/55; G06T 7/73

(52) U.S. Cl. CPC G11B 27/036; G06T 5/60; G06T 5/70; G06T 7/55; G06T 7/73; G06T 2207/10016; G06T 2207/10024; G06T 2207/20081; G06T 2207/20084; G06T 2207/20092; G06T 2207/30168; G06T 2207/30244

(57) ABSTRACT

Systems and methods are disclosed for video generation. A video subclip is extracted from a video. The video subclip includes a sequence of continuous video frames based on content determined in the video frames. A camera pose is determined in a first video frame of the video subclip. A camera pose is estimated for each video frame in the video subclip relative to the camera pose of the first video frame. An environment lighting condition is estimated for the video subclip based on the estimated camera pose of each video frame. A new video subclip is generated by placing the environment lighting condition in image latent space of the video subclip.

### CROSS-REFERENCE TO RELATED APPLICATION

This application claims the priority benefit under 35 U.S.C. § 119 (e) of U.S. Provisional Application No. 63/700,425, filed on Sep. 27, 2024, the disclosure of which is incorporated by reference in its entirety as if fully set forth herein.

### TECHNICAL FIELD

The disclosure generally relates to video editing. More particularly, the subject matter disclosed herein relates to improvements to editing 3D assets in videos.

### SUMMARY

In video editing, generative models are often utilized for digital content creation. However, many conventional models and processes do not generate videos at a desired video quality. Editing material appearance in video content utilizing conventional models and processes may not produce appearance with desired accuracy.

Conventional models and processes for material appearance editing often includes reconstruction of lighting conditions demonstrated in the original video. Existing material is often estimated, and graphics rendering for each video frame containing the material is often conducted to calculate the appearance after the material change. Conventional models and processes that include graphics rendering may be computationally intensive. Video length is often limited due to the computational demand. However, without graphics rendering, conventional models and processes may not meet expectations for spatial visual consistency or temporal visual consistency after material editing.

To overcome these issues, systems and methods are described herein for material appearance editing in video. The disclosed systems and methods do not require graphics rendering which improves efficiency over conventional systems and methods. The disclosed systems and methods provide greater precision of material appearance editing over conventional systems and methods. The disclosed systems and methods provide greater spatial visual consistency between an edited area and the surrounding environment in a video frame or video subclip over conventional systems and methods. The disclosed systems and methods provide greater temporal visual consistency across video frames in a video subclip over conventional systems and methods. Unlike many conventional systems and methods, the disclosed systems and methods are not limited by video length.

In an embodiment, a method includes extracting a video subclip from a video, the video subclip including a sequence of continuous video frames based on content determined in the video frames. The method includes determining a camera pose in a first video frame of the video subclip. The method includes estimating a camera pose for each video frame in the video subclip relative to the camera pose of the first video frame. The method includes estimating an environment lighting condition for the video subclip based on the estimated camera pose of each video frame. The method includes generating a new video subclip by placing the environment lighting condition in image latent space of the video subclip.

In an embodiment, a method includes receiving, from a user, a selected area of a video frame of a video. The method includes receiving, from the user, one or more material attributes in the selected area and one or more quantitative material adjustments for the material attributes. The method includes extracting a video subclip from the video, the video subclip including the video frame and a sequence of continuous video frames based on content determined in the video frames. The method includes determining a camera pose in a first video frame of the video subclip. The method includes estimating a camera pose for each video frame in the video subclip relative to the camera pose of the first video frame. The method includes estimating an environment lighting condition for the video subclip based on the estimated camera pose of each video frame. The method includes estimating a surface normal of the selected area on each video frame of the video subclip. The method includes estimating a depth of the selected area on each video frame of the video subclip. The method includes modifying one or more pixel colors in the selected area based on the following: the estimated surface normal of the selected area, the estimated depth of the selected area, the environment lighting condition, the material attributes, and the quantitative material adjustments.

### BRIEF DESCRIPTION OF THE DRAWING

In the following section, the aspects of the subject matter disclosed herein will be described with reference to exemplary embodiments illustrated in the figures, in which:

FIG. 1 is block diagram illustrating a system for 3D asset editing, according to an embodiment.

FIG. 2 is a flowchart illustrating a process for generating a new video subclip, according to an embodiment.

FIG. 3 is a flowchart illustrating aspects of a process for generating a new video subclip, according to an embodiment.

FIG. 4 is a flowchart illustrating a method for generating a new video subclip, according to an embodiment.

FIG. 5 is a flowchart illustrating a method for modifying pixels in a video frame, according to an embodiment.

FIG. 6 is block diagram illustrating feature injection for video generation, according to an embodiment.

FIGS. 7A and 7B illustrate alignment of environment images for a plurality of video frames, according to an embodiment.

FIG. 8 illustrates encoding of an environment lighting condition, according to an embodiment.

FIGS. 9A and 9B illustrate pixel modification for a selected area, according to an embodiment.

FIG. 10 is a block diagram illustrating an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Video subclip” as used herein refers to a segment of a video. The video subclip may comprise a plurality of continuous video frames from the video.

“Camera pose” as used herein refers to an estimated variable comprising six dimensions: a three-dimensional location and a three-dimensional orientation of a camera given an image or video captured by the camera.

“Environment lighting condition” as used herein refers to a representation of lighting across a video or video subclip.

“Environment image” as used herein refers to an image extracted from a single video frame. An environment image may be based on a color frame and a camera pose for each video frame. An environment image may be utilized to estimate an environment related to a video frame. The environment may comprise a lighting condition.

“Environment map” as used herein refers to an alignment of a plurality of environment images on a global image from a video or video subclip. The plurality of environment images may be extracted from the video or video subclip. An environment map may be constructed to estimate an environment related to the video or video subclip. The environment may comprise a plurality of pixel colors collected from the global image and the plurality of environment images. The environment map may be constructed to estimate an environment lighting condition for a video or video subclip.

“Image-to-video (I2V)” as used herein refers to a process of generating a video or video subclip from one image. The image may be extracted from a video frame.

“Diffusion model” as used herein refers to a machine learning diffusion-based generative model. A diffusion model may be utilized to generate new elements (e.g., one or more video frames) that are distributed similarly as the original elements.

“I2V model” as used herein refers to a machine learning model configured to generate a video from an image. The image may be extracted from a video frame. The image may be edited prior to utilization of an I2V model.

“I2V latent diffusion model (LDM)” as used herein refers to a machine learning model configured to generate a video from an image. An I2V LDM may be configured to operate in a compressed latent space for computational efficiency.

“U-Net” as used herein refers to a convolution neural network. When used in diffusion models, U-Net architecture may be utilized for iterative image denoising.

“U-Net based” as used herein refers to a neural network architecture following a general encoder-decoder structure with skip connections as originally described in U-Net. A U-Net based architecture may include modifications such as, for example, attention layers, residual connections, and/or normalization layers.

“Denoising Diffusion Implicit Model (DDIM) Inverse” as used herein refers to inverting a DDIM image generation process to recover latent variables (e.g., initial noise, convolution features, and attention features).

“Material appearance” as used herein refers to visual qualities of an object in a video.

Disclosed systems and methods are configured for material appearance editing in video. The material appearance may be associated with a three-dimensional (3D) object. The 3D object may be selected by a user. The 3D object may be selected by a user in the video domain. The 3D object may comprise specific properties and assets such as, for example, material appearance. The disclosed systems and methods may be configured to edit a user requested material appearance by a user requested quantitative material adjustment in a user selected area of a video. The disclosed systems and methods may be configured to edit the material in the selected area in subsequent video frames of a video subclip.

Embodiments consistent with the present disclosure may include estimating a camera pose for a video frame. The camera pose may be estimated through utilization of an image-based 3D reconstruction. A camera pose may be expressed using a two-dimensional (2D) normalized vector. A 2D normalized vector may be utilized to describe one pixel location. A pixel location may correspond to a camera viewing angle and a camera pose.

Embodiments consistent with the present disclosure may include estimating an environment lighting condition for a video subclip. A camera pose may be estimated for each video frame in the video subclip. An environment image may be extracted from each video frame based on the estimated camera pose of each video frame. Environment images extracted from each video frame may be aligned. Alignment of the environment images may be based on the estimated camera pose of each video frame. An environment map may be constructed. The environment map may comprise a global image for the video frames and the aligned environment images. The environment map may be utilized to estimate the environment lighting condition.

In an embodiment, a method may include extracting a video subclip from a video. The video subclip may include a sequence of continuous video frames based on content determined in the video frames. The method may include determining a camera pose in a first video frame of the video subclip. The method may include estimating a camera pose for each video frame in the video subclip relative to the camera pose of the first video frame. The method may include estimating an environment lighting condition for the video subclip. Estimating an environment lighting condition may be based on the estimated camera pose of each video frame. The method may include generating a new video subclip. Generating a new video subclip may include placing the environment lighting condition in image latent space of the video subclip.

In an embodiment, a method may be configured to process a video of any length.

In an embodiment, a method may be configured to process a video subclip comprising a range of, for example, 1 to 32 video frames.

In an embodiment, a method may include training a transformer-based feedforward neural network to align a plurality of environment images. Each of the environment images may be extracted from a video frame in a video subclip. Aligning the environment images may be based on an estimated camera pose for each of a plurality of video frames.

In an embodiment, a method may include utilizing a rule based method to align a plurality of environment images. Each of the environment images may be extracted from a video frame in a video subclip. Aligning the environment images may be based on an estimated camera pose for each of a plurality of video frames. Each of the environment images may be staked on a global image created from the plurality of video frames. Each of the environment images may be staked based on the camera pose of each video frame. Once the environment images have been staked on the global image, pixel colors may be collected from the global image.

In an embodiment, an environment map may be encoded utilizing an encoder. An output of the encoder may comprise an environment map feature. The environment map feature may comprise an environment lighting condition. The environment map feature may comprise an environment lighting condition representation in a latent space of a source video subclip.

In an embodiment, placing an environment lighting condition in image latent space of a video subclip may include use of an encoder. The encoder may comprise a variational autoencoder (VAE).

In an embodiment, a method may include receiving, from a user, a selected area of a video frame of a video. The method may include receiving, from the user, one or more material attributes in the selected area. The method may include receiving, from the user, one or more quantitative material adjustments for the material attributes. The method may include extracting a video subclip from the video. The video subclip may include the video frame. The video subclip may include a sequence of continuous video frames based on content determined in the video frames. The content may be changes in a background to the selected area. The subclip may be based on keeping the selected area maintained as a relatively stable appearance. The subclip may be based on keeping the background content similar across the subclip. The method may include determining a camera pose in a first video frame of the video subclip. The method may include estimating a camera pose for each video frame in the video subclip relative to the camera pose of the first video frame. The method may include estimating an environment lighting condition for the video subclip. Estimating the environment lighting condition may be based on the estimated camera pose of each video frame. The method may include estimating a surface normal of the selected area on each video frame of the video subclip. Limiting a surface normal to the selected area may preserve the original appearance of the rest of the video frame. The method may include estimating a depth of the selected area on each video frame of the video subclip. Limiting a depth to the selected area may preserve the original appearance of the rest of the video frame. The method may include modifying one or more pixel colors in the selected area. Limiting pixel modification to the selected area may preserve the original appearance of the rest of the video frame. Modifying one or more pixel colors may be based on at least one of the following: the estimated surface normal of the selected area, the estimated depth of the selected area, the environment lighting condition, the material attributes, and/or the quantitative material adjustments.

In an embodiment, an estimated surface normal of a selected area, an estimated depth of the selected area, and an environment map feature may be concatenated on a video frame along channels. This concatenation is an example of pixel modification. For example, a video frame may contain 3D data: width, height, and channels. The channels may contain red, green, and blue (i.e., RGB) information, forming a 3D vector at each pixel. Concatenating the estimated surface normal, the estimated surface depth, and the environment map feature along channels may comprising stacking the estimated surface normal (3D vector at each pixel), the estimated surface depth (1D vector at each pixel), and the environment map feature (10D vector at each pixel) into a 3+1+10=14D vector at each pixel location.

Embodiments consistent with the present disclosure may include a material attribute. A material attribute may be related to a material appearance in a video. A material attribute may include at least one of the following: roughness, metallic, transparency, and/or albedo. Embodiments consistent with the present disclosure may include a quantitative material adjustment for a material attribute. A quantitative material adjustment may comprise a desired material adjustment, expressed quantitatively.

Embodiments consistent with the present disclosure may include receiving, from a user, a selected area of a video frame of a video. The selected area may include an object with one or more material properties. Embodiments consistent with the present disclosure may include receiving, from a user, one or more material attributes in the selected area and/or one or more quantitative material adjustments for the material attributes.

In an embodiment, a user may communicate a material attribute and a quantitative material adjustment for the material attribute using a text prompt. For example, a material attribute and a quantitative material adjustment for a material attribute may comprise “change roughness of the table by −0.45”. In another example, a material attribute and a quantitative material adjustment for a material attribute may comprise “change transparency by +0.48”.

In an embodiment, a method may include aligning a plurality of environment images. Each of the environment images may be extracted from a video frame in a video subclip. Aligning the environment images may be based on an estimated camera pose for each of a plurality of video frames.

In an embodiment, extracting a video subclip from a video may be based on identifying key frames in the video.

In an embodiment, a method may include determining initial noise, convolution features, and attention features of each video frame in a video subclip. The method may include editing the first video frame of the video subclip to generate an edited frame. The edited frame may be based on the following: a selected area, one or more material attributes related to the selected area, and one or more quantitative material adjustments for the one or more material attributes. The selected area, the one or more material attributes related to the selected area, and the one or more quantitative material adjustments for the one or more material attributes may be requested by a user. The method may include generating a new video subclip. The new video subclip may be based on: the edited frame, the initial noise of each video frame in the video subclip, and the selected area, the one or more material attributes related to the selected area, and the one or more quantitative material adjustments for the one or more material attributes. The method may be configured to preserve motion information contained in the video subclip (i.e., the original video subclip, prior to editing).

In an embodiment, determining initial noise, convolution features, and attention features may include conducting a DDIM inversion computation. A DDIM inversion may be utilized to extract latent representations of initial noise, convolution features, and attention features from a video frame.

In an embodiment, editing a first video frame in a video subclip may include utilizing a diffusion model for single image editing. A camera pose may be injected for each video frame in the video subclip.

In an embodiment, generating a new video subclip may include injecting some of the convolution features generated during a DDIM inversion computation into a U-Net-based I2V LDM. The U-Net based I2V LDM may comprise attention layers. Generating a new video subclip may include injecting some of the attention features generated during a DDIM inversion computation into the U-Net-based I2V LDM.

In an embodiment, generating a new video subclip may include injecting an estimated surface normal into a U-net-based diffusion model. The U-Net based diffusion model may comprise attention layers. The surface normal may be estimated for a selected area. . . . Generating a new video subclip may include injecting an estimated depth into the U-net-based diffusion model. The depth may be estimated for the selected area. Generating a new video subclip may include injecting an environment lighting condition into the U-net-based diffusion model. The environment lighting condition may be estimated by constructing an environment map.

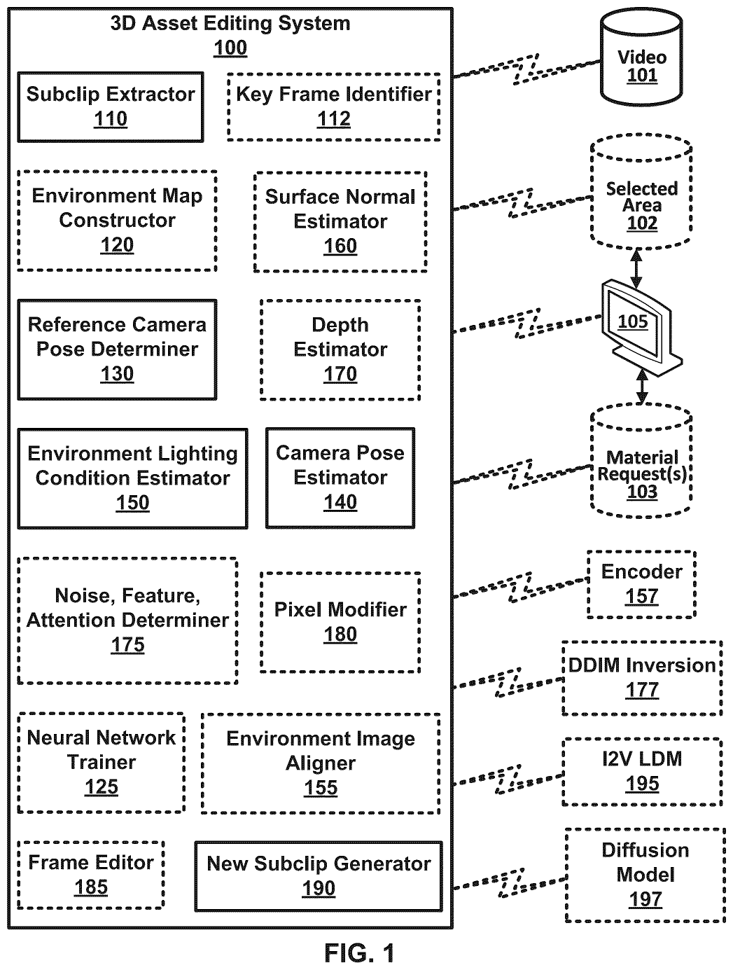

FIG. 1 is block diagram illustrating a system 100 for 3D asset editing, according to an embodiment.

Referring to FIG. 1, a system 100, configured for 3D asset editing, may comprise a subclip extractor 110. Subclip extractor 110 may be configured to extract a video subclip from video 101. Video 101 may be accessible to system 100 via a network (e.g., 1398 or 1399).

System 100 may comprise a key frame identifier 112. Key frame identifier 112 may be utilized to extract a video subclip from video 101.

System 100 may comprise an environment map constructor 120. Environment map constructor 120 may be configured to construct an environment map.

System 100 may comprise a reference camera pose determiner 130. Reference camera pose determiner 130 may be configured to determine a reference camera pose. A reference camera pose may be a camera pose for a first video frame of video 101 or a video subclip. System 100 may comprise a camera pose estimator 140. Camera pose estimator 140 may be configured to estimate a camera pose for one or more video frames subsequent to a first video frame of video 101 or a video subclip. The camera pose may be relative to a reference camera pose.

System 100 may comprise an environment lighting condition estimator 150. Environment lighting condition estimator 150 may be configured to estimate an environment lighting condition for video 101 or a video subclip. Placing the environment lighting condition in image latent space of the video subclip may utilize an encoder 157. Encoder 157 may be accessible to system 100 via a network (e.g., 1398 or 1399).

System 100 may comprise a surface normal estimator 160. Surface normal estimator 160 may be configured to estimate a surface normal of a selected area 102 for one or more video frames of video 101 or a video subclip. Selected area 102 may be accessible to system 100 via a network (e.g., 1398 or 1399). Selected area 102 may be communicated from a user system 105 via a network (e.g., 1398 or 1399). User system 105 may be accessible to system 100 via a network (e.g., 1398 or 1399).

System 100 may comprise a depth estimator 170. Depth estimator 170 may be configured to estimate a depth of a selected area 102 for one or more video frames of video 101 or a video subclip.

System 100 may comprise a noise, feature, attention determiner 175. Noise, feature, attention determiner 175 may be configured to determine initial noise, convolution features, and attention features of each video frame in video 101 or a video subclip. DDIM inversion 177 may be conducted to compute the initial noise, convolution features, and attention features for one or more video frames of video 101 or a video subclip. DDIM inversion 177 may be accessible to system 100 via a network (e.g., 1398 or 1399).

System 100 may comprise a pixel modifier 180. Pixel modifier 180 may be configured to modify one or more pixel colors of selected area 102 in one or more video frames of video 101 or a video subclip. Modifying one or more pixel colors may be based on an estimated surface normal of selected area 102. Modifying one or more pixel colors may be based on an estimated depth of selected area 102. Modifying one or more pixel colors may be based on an environment lighting condition. Modifying one or more pixel colors may be based on one or more material attributes. One or more material attributes may be part of material requests 103. Material requests 103 may be accessible to system 100 via a network (e.g., 1398 or 1399). Material requests 103 may be communicated from user system 105 via a network (e.g., 1398 or 1399). Modifying one or more pixel colors may be based on quantitative material adjustments. Quantitative material adjustments may be part of material requests 103.

System 100 may comprise an environment image aligner 155. Environment image aligner 155 may be configured to align a plurality of environment images.

System 100 may comprise a neural network trainer 125. Neural network trainer 125 may be configured to train a neural network to align a plurality of environment images The neural network may comprise a feedforward neural network. The neural network may comprise a transformer-based neural network.

System 100 may comprise a frame editor 185. Frame editor 185 may be configured to edit a first video frame of video 101 or a video subclip. Frame editor 185 may be configured to generate an edited frame. The edited frame may be based on one or more material attributes and one or more quantitative material adjustments. The edited frame may be generated through use of a diffusion model for single image editing.

System 100 may comprise a new subclip generator 190. New subclip generator 190 may be configured to generate a new video subclip. The new video subclip may be generated by placing an environment lighting condition in image latent space of a video subclip. The new video subclip may be based on an edited frame. The new video subclip may be based on initial noise of each video frame in a video subclip. The new video subclip may be based on the selected area 102 and the material requests 103. Generating a new video subclip may utilize I2V LDM 195. I2V LDM 195 may be accessible to system 100 via a network (e.g., 1398 or 1399). Generating a new video subclip may utilize diffusion model 197. Diffusion model 197 may be accessible to system 100 via a network (e.g., 1398 or 1399).

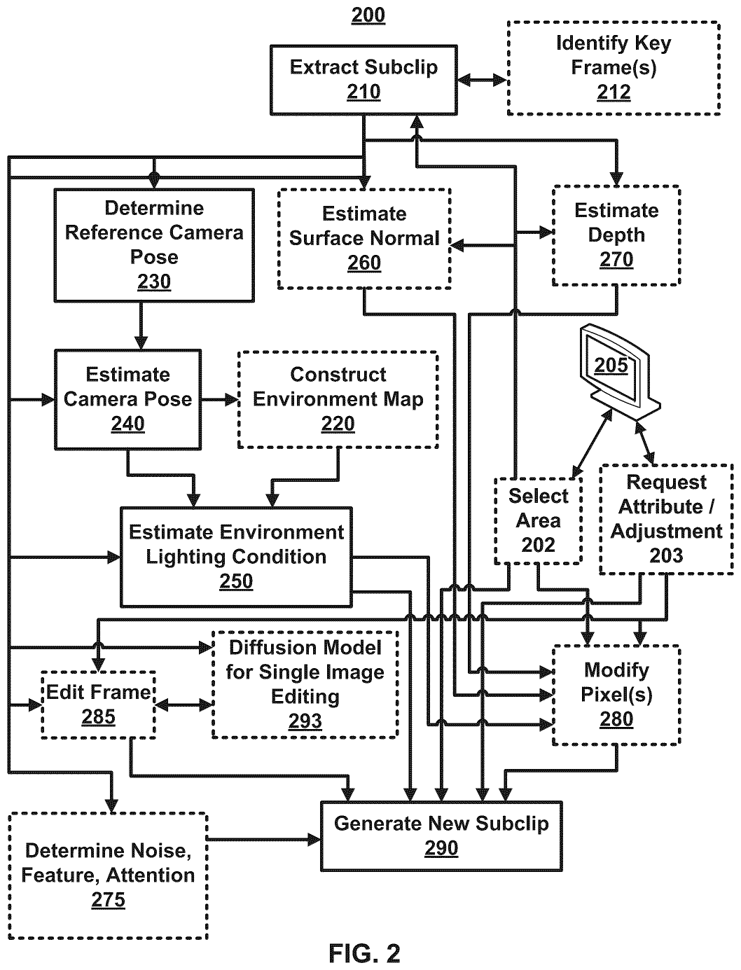

FIG. 2 is a flowchart illustrating a process 200 for generating a new video subclip, according to an embodiment.

Referring to FIG. 2, a video subclip may be extracted at 210. The video subclip may be based on identifying one or more key frames at 212. A reference camera pose may be determined at 230. The reference camera pose may comprise a camera pose for a first video frame in the video subclip. A camera pose for one or more subsequent video frames may be estimated at 240. A camera pose may be relative to the camera pose for the first video frame in the video subclip. An environment lighting condition may be estimated for the video subclip at 250. The environment lighting condition may be based on the estimated camera pose of each video frame in the video subclip. An environment map may be constructed at 220. The environment map may be utilized to estimate the environment lighting condition for the video subclip.

An area 202 of a video frame of the video may be selected by a user. The user may utilize electronic device 205 to select the area 202. A surface normal of the selected area 202 may be estimated at 260. A depth of the selected area 202 may be estimated at 270. The user may request one or more quantitative material adjustments for one or more material attributes 203 in the selected area 202. The user may utilize electronic device 205 to request the one or more material attributes and the one or more quantitative material adjustments 203. One or more pixel colors in the selected area 202 may be modified at 280. The one or more pixel colors may be modified based on the estimated surface normal of the selected area 202. The one or more pixel colors may be modified based on the estimated depth of the selected area 202. The one or more pixel colors may be modified based on the environment lighting condition. The one or more pixel colors may be modified based on the material attributes and the quantitative material adjustments 203. Initial noise, convolution features, and attention features of each video frame in the video subclip may be determined at 275. The first video frame of the video subclip may be edited at 285. The first video frame of the video subclip may be edited to generate an edited frame based on the selected area, the material attributes, and the quantitative material adjustments 203. The first video frame of the video subclip may be edited by utilizing a diffusion model for single image editing at 293. A new video subclip may be generated at 290. The new video subclip may be generated by placing the environment lighting condition in image latent space of the video subclip. The new video subclip may be based on the edited frame. The new video subclip may be based on the initial noise of each video frame in the video subclip. The new video subclip may be based on the selected area, the material attributes, and the quantitative material adjustments.

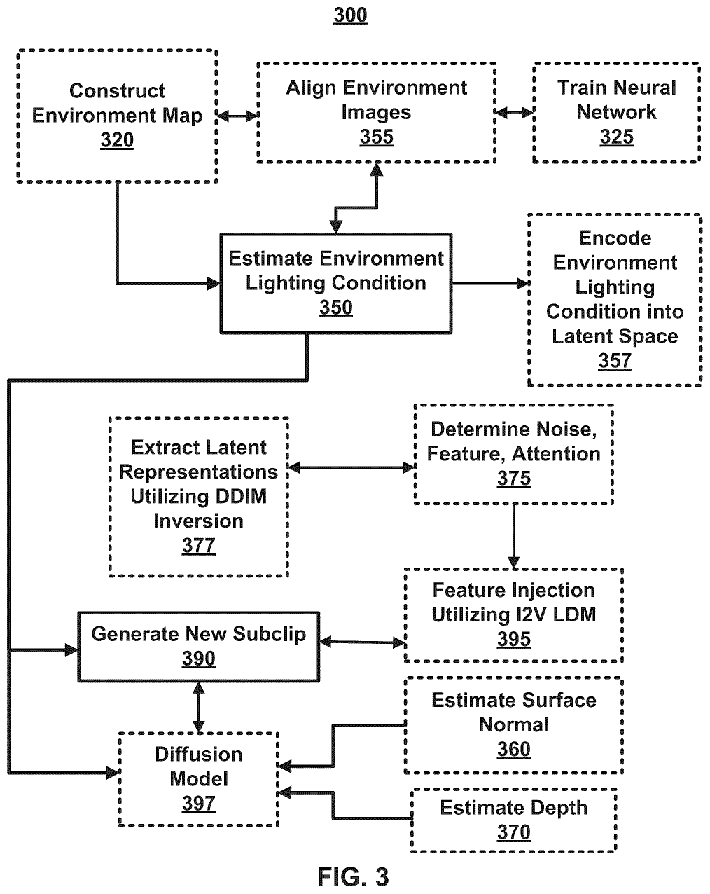

FIG. 3 is a flowchart illustrating aspects of a process 300 for generating a new video subclip, according to an embodiment.

Referring to FIG. 3, a plurality of environment images may be aligned at 355. An environment map may be constructed at 320. A neural network may be trained at 325 to align the plurality of environment images. The neural network may be a feedforward neural network. The neural network may be a transformer-based feedforward neural network. An environment lighting condition may be estimated for a video subclip at 350. A new video subclip may be generated by encoding the environment lighting condition in image latent space of the video subclip at 357. Initial noise, convolution features, and attention features of each video frame in the video subclip may be determined at 375. Determining the initial noise, convolution features, and attention features may comprise utilizing a DDIM inversion to extract latent representations at 377. A surface normal of a selected area may be estimated at 360. A depth of the selected area may be estimated at 370. A new video subclip may be generated at 390. Generating a new video subclip may comprise feature injection utilizing an I2V LDM at 395. Feature injection may include some of the convolution features and some of the attention features. Generating a new video subclip may comprise injecting the following into a diffusion model at 397: the estimated surface normal, the estimated depth, and the environment lighting condition.

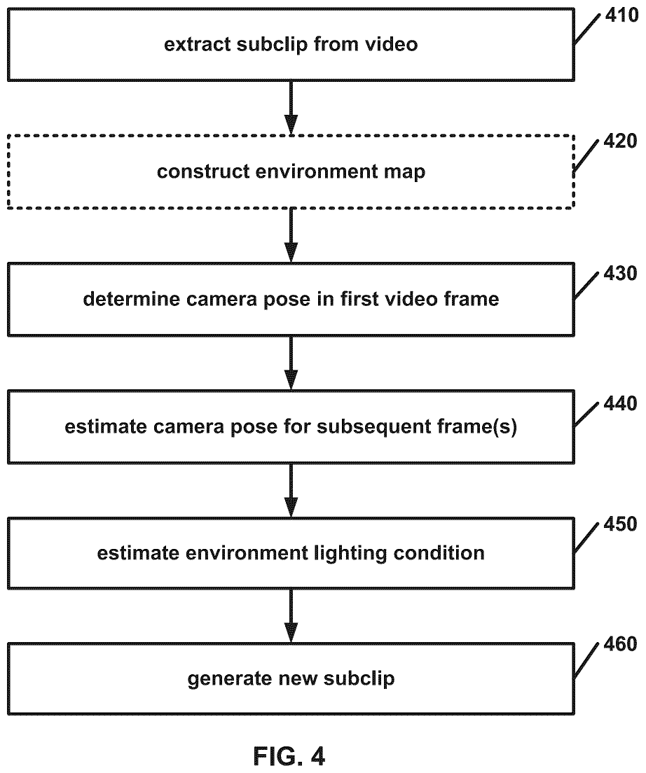

FIG. 4 is a flowchart illustrating a method for generating a new video subclip, according to an embodiment.

Referring to FIG. 4, a video subclip may be extracted from a video at 410. An environment map may be constructed at 420. A camera pose in a first video frame of the video subclip may be determined at 430. A camera pose for one or more subsequent video frames in the video subclip may be estimated at 440. An environment lighting condition may be estimated for the video subclip at 450. A new video subclip may be generated at 460.

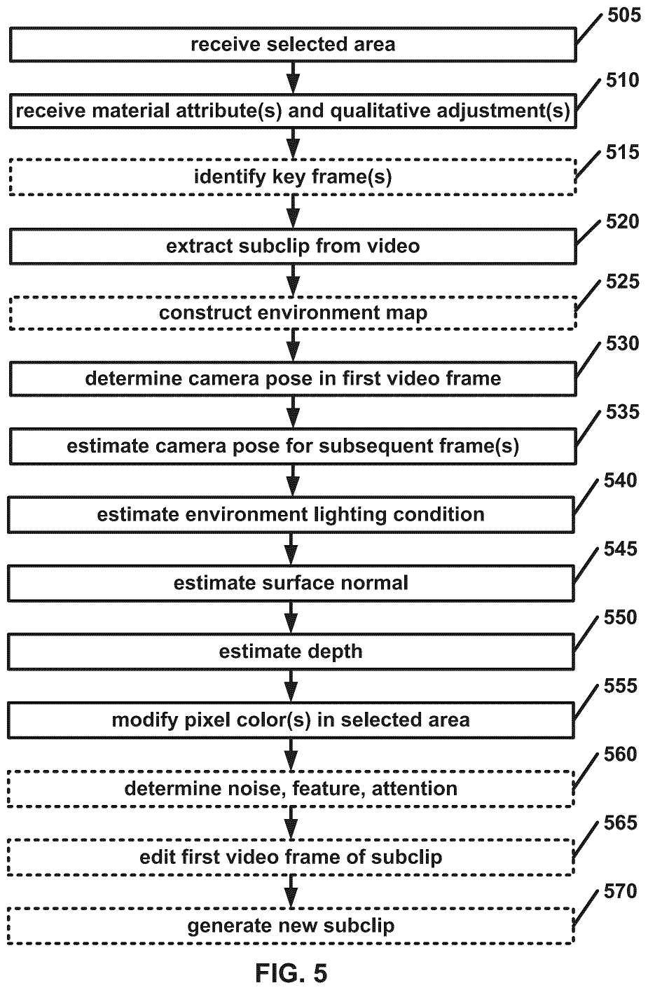

FIG. 5 is a flowchart illustrating a method for modifying pixels in a video frame, according to an embodiment.

Referring to FIG. 5, an area in a video frame may be selected by a user. The selected area may be received from the user at 505. One or more material attributes and one or more qualitative material adjustments related to the material attributes may be received from the user at 510. Key frames of a video may be identified at 515. A video subclip may be extracted from the video at 520. The video subclip may include the video frame. The video subclip may be based on the key frames. An environment map may be constructed at 525. The environment map may be utilized to estimate an environment lighting condition for the video subclip. A camera pose in a first video frame of the video subclip may be determined at 530. A camera pose for one or more subsequent video frames in the video subclip may be estimated at 535. The estimated camera pose for the one or more subsequent video frames may be relative to the camera pose of the first video frame of the video subclip. An environment lighting condition may be estimated for the video subclip at 540. A surface normal of the selected area may be estimated at 545. The surface normal of the selected area may be estimated in one or more video frames of the video subclip. A depth of the selected area may be estimated at 550. The depth of the selected area may be estimated in one or more video frames of the video subclip. One or more pixel colors may be modified in the selected area at 555. Initial noise, convolution features, and attention features of one or more video frames in the video subclip may be determined at 560. The first video frame of the video subclip may be edited at 565 to generate an edited frame. The edited frame may be based on the selected area, the material attributes, and the quantitative material adjustments. A new video subclip may be generated at 570. The new video subclip may be based on the edited frame. The new video subclip may be based on the initial noise of each video frame in the video subclip. The new video subclip may be based on the selected area. The new video subclip may be based on the one or more material attributes. The new video subclip may be based on the one or more qualitative material adjustments related to the material attributes.

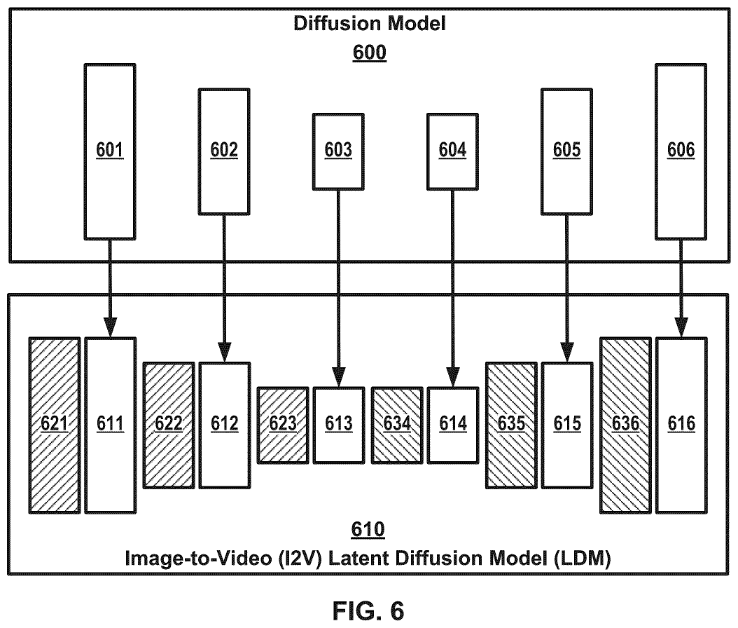

FIG. 6 is block diagram illustrating feature injection for video generation, according to an embodiment.

Referring to FIG. 6, a video subclip may comprise a plurality of video frames. The video subclip may be input to an I2V LDM 610 to conduct a DDIM inversion computation. The I2V LDM 610 may be a U-Net-based I2V LDM. Intermediate data produced during the DDIM inversion computation may include resulted convolution features and resulted attention features. The end result of the DDIM inversion computation may include initial noise.

The first video frame in the video subclip may be edited based on a user input including: a selected area, one or more material attributes in the selected area, and one or more quantitative material adjustments for the material attributes. The edited video frame may be used as the first video frame in a new video subclip. The edited frame may be used as input to the I2V LDM 610 along with the initial noise and the user input.

Some of the convolution features and some of the attention features from the DDIM inversion computation may be injected into the I2V LDM 610. Blocks 621, 622, and 623 each represent the injected features.

Estimated surface normal of the selected area, estimated depth of the selected area, and an environment lighting condition for the video subclip may be input to a diffusion model 600. The diffusion model 600 may be a U-Net-based diffusion model. The diffusion model 600 may be trained on image data. The diffusion model 600 may be utilized to reduce noise in a generated image. The diffusion model 600 may share the same neural network structure with the I2V LDM 610.

Blocks 601, 602, 603, 604, 605, and 606 each represent the resulted intermediate data in each layer of the diffusion model 600 when inference is conducted. The resulted intermediate data in each layer of the diffusion model 600 may be injected into the I2V LDM 610. Blocks 611, 612, 613, 614, 615, and 616 each represent the injected data.

Blocks 634, 635, and 636 each represent features that are calculated using the input to each neural network kernel and the weights on each kernel.

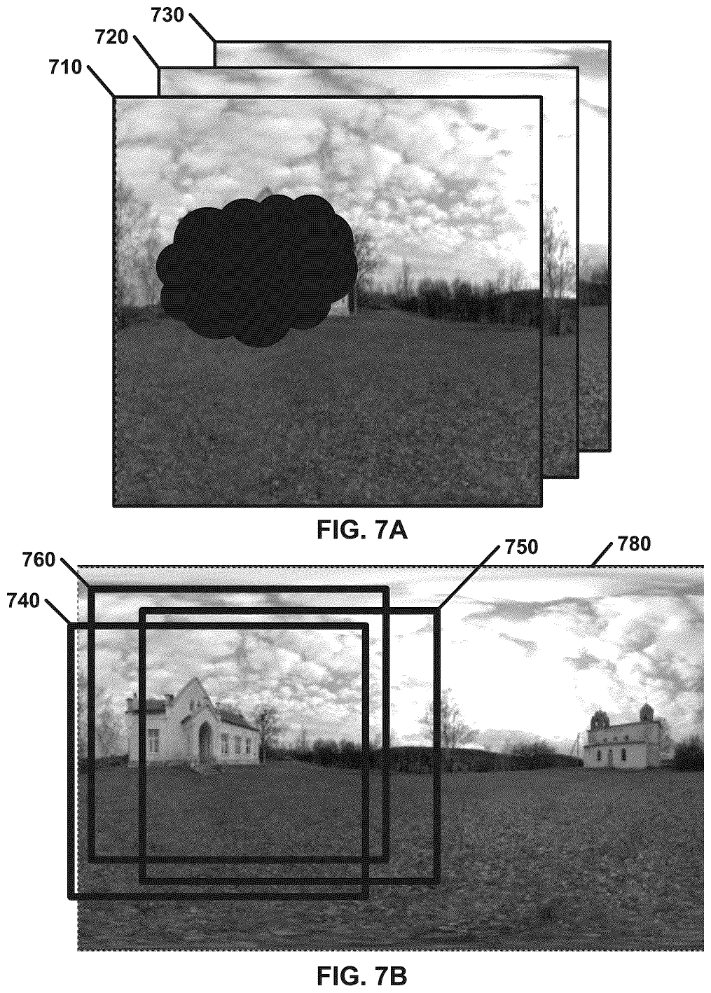

FIGS. 7A and 7B illustrate alignment of environment images for a plurality of video frames, according to an embodiment.

Referring to FIG. 7A, a camera pose may be estimated for each video frame in a video subclip. An environment image 710, 720, and 730 may be extracted from each video frame based on the estimated camera pose of each video frame.

Referring to FIG. 7B, the environment images (e.g., 710, 720, and 730) extracted from each video frame may be aligned as illustrated in 740, 750, and 760. Alignment may be based on an estimated camera pose of each video frame. An environment map 780 may be constructed. An environment map 780 may comprise a global image for the video frames and the aligned environment images 740, 750, and 760.

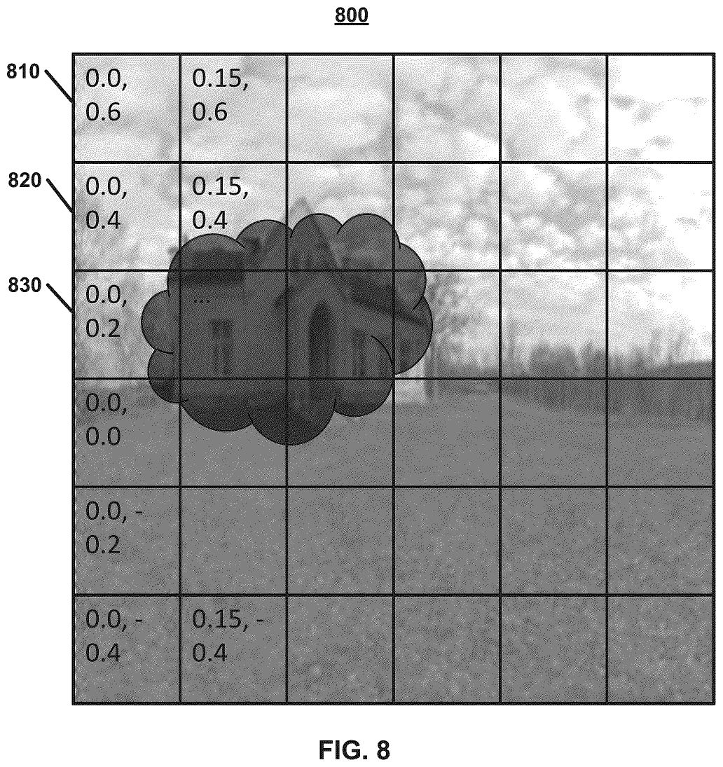

FIG. 8 illustrates encoding of an environment lighting condition, according to an embodiment.

Referring to FIG. 8, a camera pose of each pixel on an environment image may be expressed using a two-dimensional (2D) normalized vector. A 2D normalized vector may be utilized to describe one pixel location. A pixel location may correspond to a camera viewing angle and a camera pose. For illustration purposes, the environment image 800 has been divided into blocks including blocks 810, 820, and 830. Block 810 may comprise a pixel location that may be described by a 2D normalized vector 0.0, 0.6. Block 820 may comprise a pixel location that may be described by a 2D normalized vector 0.0, 0.4. Block 830 may comprise a pixel location that may be described by a 2D normalized vector 0.0, 0.2 and so on. An environment map (e.g., 780) comprising a sequence of environment images may be used to estimate an environment lighting condition for a video or video subclip. The environment map may be encoded utilizing an encoder. An output of the encoder may comprise an environment map feature. The environment map feature may be placed into the latent space. For example, an environment map may comprise a height=256, a width=256 and channels=3. After utilizing an encoder (e.g., a VAE), an environment map feature may comprise a height=32, a width=32 and channels=10.

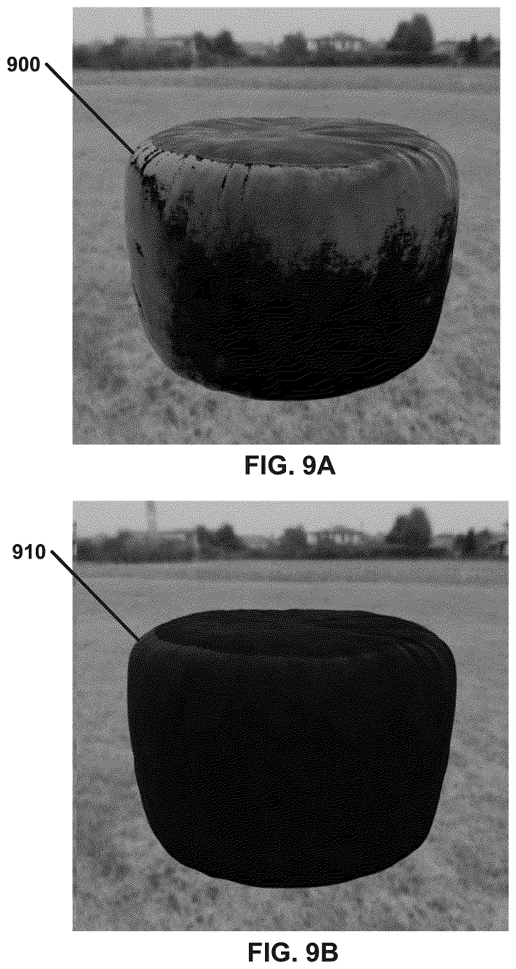

FIGS. 9A and 9B illustrate pixel modification for a selected area, according to an embodiment.

Referring to FIG. 9A, a user may select object 900 (i.e., a selected area) from a video frame in a video. Object 900 may comprise a plurality of material attributes comprising, for example, roughness and metallic. In this example, object 900 comprises low roughness and high metallic.

Referring to FIG. 9B, a user may request one or more material attributes in a selected area and one or more quantitative material adjustments for the material attributes. In this example, the user may, with respect to object 900, request “change roughness to high” and “change metallic to low”. Object 910 may be the result of editing a video frame comprising object 900, according to disclosed embodiments, given the requests by the user.

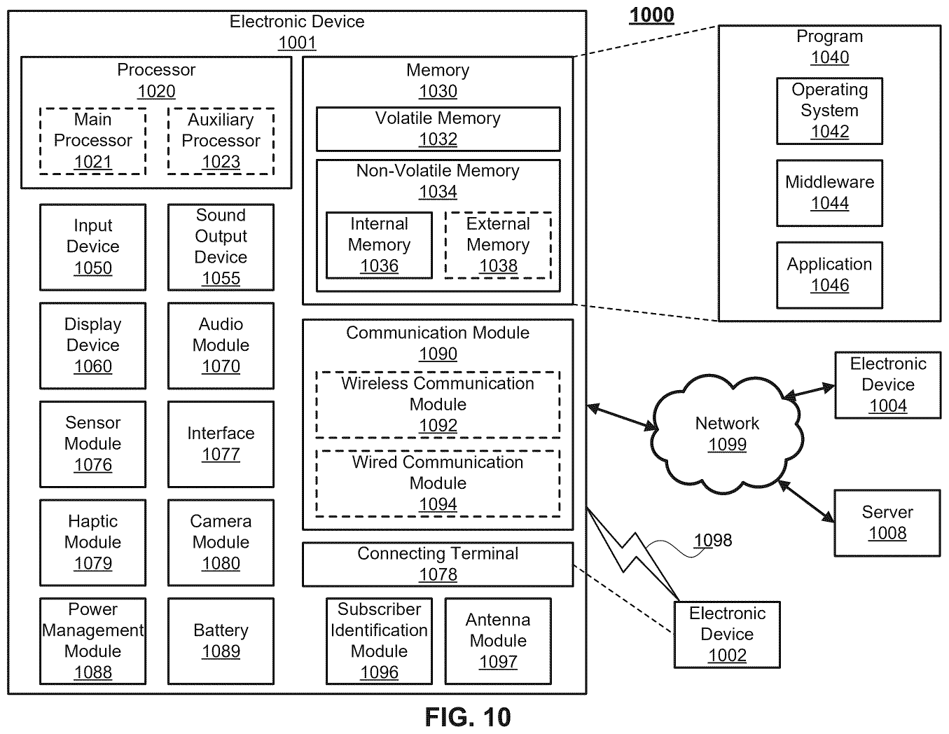

FIG. 10 is a block diagram illustrating an electronic device in a network environment, according to an embodiment.

FIG. 10 is a block diagram of an electronic device in a network environment 1000, according to an embodiment.

Referring to FIG. 10, an electronic device 1001 in a network environment 1000 may communicate with an electronic device 1002 via a first network 1098 (e.g., a short-range wireless communication network), or an electronic device 1004 or a server 1008 via a second network 1099 (e.g., a long-range wireless communication network). The electronic device 1001 may communicate with the electronic device 1004 via the server 1008. The electronic device 1001 may include a processor 1020, a memory 1030, an input device 1050, a sound output device 1055, a display device 1060, an audio module 1070, a sensor module 1076, an interface 1077, a haptic module 1079, a camera module 1080, a power management module 1088, a battery 1089, a communication module 1090, a subscriber identification module (SIM) card 1096, or an antenna module 1097. In one embodiment, at least one (e.g., the display device 1060 or the camera module 1080) of the components may be omitted from the electronic device 1001, or one or more other components may be added to the electronic device 1001. Some of the components may be implemented as a single integrated circuit (IC). For example, the sensor module 1076 (e.g., a fingerprint sensor, an iris sensor, or an illuminance sensor) may be embedded in the display device 1060 (e.g., a display).

The processor 1020 may execute software (e.g., a program 1040) to control at least one other component (e.g., a hardware or a software component) of the electronic device 1001 coupled with the processor 1020 and may perform various data processing or computations.

As at least part of the data processing or computations, the processor 1020 may load a command or data received from another component (e.g., the sensor module 1076 or the communication module 1090) in volatile memory 1032, process the command or the data stored in the volatile memory 1032, and store resulting data in non-volatile memory 1034. The processor 1020 may include a main processor 1021 (e.g., a central processing unit (CPU) or an application processor (AP)), and an auxiliary processor 1023 (e.g., a graphics processing unit (GPU), an image signal processor (ISP), a sensor hub processor, or a communication processor (CP)) that is operable independently from, or in conjunction with, the main processor 1021. Additionally or alternatively, the auxiliary processor 1023 may be adapted to consume less power than the main processor 1021, or execute a particular function. The auxiliary processor 1023 may be implemented as being separate from, or a part of, the main processor 1021.

The auxiliary processor 1023 may control at least some of the functions or states related to at least one component (e.g., the display device 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). The auxiliary processor 1023 (e.g., an image signal processor or a communication processor) may be implemented as part of another component (e.g., the camera module 1080 or the communication module 1090) functionally related to the auxiliary processor 1023.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034. Non-volatile memory 1034 may include internal memory 1036 and/or external memory 1038.

The program 1040 may be stored in the memory 1030 as software, and may include, for example, an operating system (OS) 1042, middleware 1044, or an application 1046.

The input device 1050 may receive a command or data to be used by another component (e.g., the processor 1020) of the electronic device 1001, from the outside (e.g., a user) of the electronic device 1001. The input device 1050 may include, for example, a microphone, a mouse, or a keyboard.

The sound output device 1055 may output sound signals to the outside of the electronic device 1001. The sound output device 1055 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1060 may visually provide information to the outside (e.g., a user) of the electronic device 1001. The display device 1060 may include, for example, a display, a hologram device, or a projector and control circuitry to control a corresponding one of the display, hologram device, and projector. The display device 1060 may include touch circuitry adapted to detect a touch, or sensor circuitry (e.g., a pressure sensor) adapted to measure the intensity of force incurred by the touch.

The audio module 1070 may convert a sound into an electrical signal and vice versa. The audio module 1070 may obtain the sound via the input device 1050 or output the sound via the sound output device 1055 or a headphone of an external electronic device 1002 directly (e.g., wired) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. The sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device 1002 directly (e.g., wired) or wirelessly. The interface 1077 may include, for example, a high-definition multimedia interface (HDMI), a universal serial bus (USB) interface, a secure digital (SD) card interface, or an audio interface.

A connecting terminal 1078 may include a connector via which the electronic device 1001 may be physically connected with the external electronic device 1002. The connecting terminal 1078 may include, for example, an HDMI connector, a USB connector, an SD card connector, or an audio connector (e.g., a headphone connector).

The haptic module 1079 may convert an electrical signal into a mechanical stimulus (e.g., a vibration or a movement) or an electrical stimulus which may be recognized by a user via tactile sensation or kinesthetic sensation. The haptic module 1079 may include, for example, a motor, a piezoelectric element, or an electrical stimulator.

The camera module 1080 may capture a still image or moving images. The camera module 1080 may include one or more lenses, image sensors, image signal processors, or flashes. The power management module 1088 may manage power supplied to the electronic device 1001. The power management module 1088 may be implemented as at least part of, for example, a power management integrated circuit (PMIC).

The battery 1089 may supply power to at least one component of the electronic device 1001. The battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the AP) and supports a direct (e.g., wired) communication or a wireless communication. The communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as BLUETOOTH™, wireless-fidelity (Wi-Fi) direct, or a standard of the Infrared Data Association (IrDA)) or the second network 1099 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The antenna module 1097 may transmit or receive a signal or power to or from the outside (e.g., the external electronic device) of the electronic device 1001. The antenna module 1097 may include one or more antennas, and, therefrom, at least one antenna appropriate for a communication scheme used in the communication network, such as the first network 1098 or the second network 1099, may be selected, for example, by the communication module 1090 (e.g., the wireless communication module 1092). The signal or the power may then be transmitted or received between the communication module 1090 and the external electronic device via the selected at least one antenna.

Commands or data may be transmitted or received between the electronic device 1001 and the external electronic device 1004 via the server 1008 coupled with the second network 1099. Each of the electronic devices 1002 and 1004 may be a device of a same type as, or a different type, from the electronic device 1001. All or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1001. The electronic device 1001 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
extracting a video subclip from a video, the video subclip including a sequence of continuous video frames based on content determined in the video frames;
determining a camera pose in a first video frame of the video subclip;
estimating a camera pose for each video frame in the video subclip relative to the camera pose of the first video frame;
estimating an environment lighting condition for the video subclip based on the estimated camera pose of each video frame; and
generating a new video subclip by placing the environment lighting condition in image latent space of the video subclip.

2. The method of claim 1, wherein the video may comprise any length.

3. The method of claim 1, wherein the video subclip comprises a length in a range of 1 to 32 video frames.

4. The method of claim 1, further comprising training a transformer-based feedforward neural network to align a plurality of environment images, each of the environment images extracted from a video frame in the video subclip, the plurality of environment images aligned based on the estimated camera pose for each video frame.

5. The method of claim 1, wherein placing the environment lighting condition in image latent space of the video subclip comprises use of an encoder.

6. The method of claim 5, wherein the encoder comprises a variational autoencoder (VAE).

7. A method comprising:
receiving, from a user, a selected area of a video frame of a video;
receiving, from the user, one or more material attributes in the selected area and one or more quantitative material adjustments for the material attributes;
extracting a video subclip from the video, the video subclip including the video frame and a sequence of continuous video frames based on content determined in the video frames;
determining a camera pose in a first video frame of the video subclip;
estimating a camera pose for each video frame in the video subclip relative to the camera pose of the first video frame;
estimating an environment lighting condition for the video subclip based on the estimated camera pose of each video frame;
estimating a surface normal of the selected area on each video frame of the video subclip;
estimating a depth of the selected area on each video frame of the video subclip; and
modifying one or more pixel colors in the selected area based on the following:
the estimated surface normal of the selected area;
the estimated depth of the selected area;
the environment lighting condition;
the material attributes; and
the quantitative material adjustments.

8. The method of claim 7, wherein the video may comprise any length.

9. The method of claim 7, further comprising aligning a plurality of environment images, each of the environment images extracted from a video frame in the video subclip, the plurality of environment images aligned based on the estimated camera pose for the video frame.

10. The method of claim 9, further comprising training a transformer-based feedforward neural network to align the plurality of environment images.

11. The method of claim 7, further comprising encoding the environment lighting condition in image latent space of the video subclip utilizing an encoder.

12. The method of claim 11, wherein the encoder comprises a variational autoencoder (VAE).

13. The method of claim 7, wherein the material attributes comprise at least one of the following: roughness, metallic, transparency, or albedo.

14. The method of claim 7, further comprising identifying key frames in the video, the video subclip based on the keyframes.

15. The method of claim 7, further comprising:
determining initial noise, convolution features, and attention features of each video frame in the video subclip;
editing the first video frame of the video subclip to generate an edited frame based on the selected area, material attributes, and the quantitative material adjustments; and
generating a new video subclip based on:
the edited frame
the initial noise of each video frame in the video subclip; and
the selected area, the material attributes, and the quantitative material adjustments.

16. The method of claim 15, wherein determining the initial noise, the convolution features, and the attention features comprises conducting a denoising diffusion implicit model (DDIM) inversion computation.

17. The method of claim 15, wherein editing the first video frame comprises utilizing a diffusion model for single image editing.

18. The method of claim 15, wherein generating the new video subclip comprises utilizing a U-Net-based image to video (I2V) latent diffusion model (LDM).

19. The method of claim 18, wherein generating the new video subclip further comprises injecting the following into the U-Net-based I2V LDM:
some of the convolution features; and
some of the attention features.

20. The method of claim 15, wherein generating the new video subclip further comprises injecting the following into a U-net-based diffusion model:
the estimated surface normal;
the estimated depth; and
the environment lighting condition.
